(19) United States
(12) Patent Application Publication
(10) Pub. No.: US 2026/0365322 A1
(43) Pub. Date: Nov. 19, 2026

(54) Aircraft Condition Monitoring

(71) Applicant: Textron Aviation Inc., Wichita, KS (US)

(72) Inventors: Mark Adam McCarthy, Wichita, KS (US); Geoffrey Acheson Bleakley, Wichita, KS (US); Holly Kimberlin Donaldson, Wichita, KS (US); Joshua Peter Racchini, Rose Hill, KS (US)

(21) Appl. No.: 19/208,358

(22) Filed: May 14, 2025

(51) Int. Cl. B64D 45/00

(52) U.S. Cl. CPC B64D 45/00; B64D 2045/0065; B64D 2045/0085

(57) ABSTRACT

Systems and methods are disclosed for processing predictive aircraft sensor parameters in the context of conditions associated with aircraft sensor data from an aircraft recording system (ARS) that is associated with a monitored aircraft. Newly received aircraft sensor values are captured over the course of several aircraft flights. The ARS captures the newly received aircraft sensor values associated with aircraft sensors in the monitored aircraft. User-provided logic query conditions indicative of events that are relevant to the aircraft predictive maintenance determinations are received. A relevant subset of the newly received aircraft sensor values is staged into a cloud storage repository associated with a serverless cloud tenant for performing batch processing on the relevant subset of the newly received aircraft sensor values in connection with one or more data warehouses. Condition monitoring outputs are generated based on the user-provided logic query conditions and the relevant subsets of the staged ARS data.

### BACKGROUND

### 1. Field

Embodiments of the invention relate generally to aircraft data analytics and condition monitoring, and more specifically to systems and methods for monitoring, filtering, and persisting predictive aircraft data in connection with a highly performant data warehousing solution.

### 2. Related Art

Various methods for aircraft condition monitoring are known that utilize flight data to monitor the performance of aircraft systems and components. Such aircraft condition monitoring systems can be used to identify potential defects in one or more aircraft components before an actual failure occurs. Aircraft condition monitoring systems involve ongoing measurement of aircraft sensor values to identify early signs of aircraft component degradation. Such strategies may be employed to potentially avoid unscheduled aircraft maintenance. However, ongoing measurement and recording of aircraft sensor data results in massive amounts of data causing existing aircraft conditioning monitoring systems to consume vast amount of storage and computing resources and resulting in limited querying possibilities and long interactive response times. Such an endeavor conventionally requires manually plotting out individual Aircraft Recording System (ARS) flight file parameters and visually inspecting them for phenomena of interest. This frequently requires searching through many flight files before finding an applicable data set associated with when a particular phenomenon was first observed, in order confirm relevance of the observed parameters of interest. Identifying such data sets is time consuming and error prone. Even once such a data set is identified, processing such large datasets is cumbersome and resource intensive.

Accordingly, there is a need for aircraft data analytics and condition monitoring systems that provide highly performant methods for monitoring, filtering, persisting, and reporting on important aircraft data.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention may be apparent from the following detailed description of the embodiments and the accompanying drawing figures.

In particular, an embodiment includes an aircraft condition monitoring system for analyzing aircraft data associated with one or more monitored aircraft, the aircraft condition monitoring system comprising: at least one aircraft recording system (ARS) for capturing a plurality of aircraft sensor values over the course of a plurality of flights of the one or more monitored aircraft, wherein the at least one ARS captures aircraft sensor values associated with a plurality of aircraft sensors, one or more data acquisition endpoints associated with the aircraft recording system, for staging newly acquired ARS data as staged ARS data is received from aircraft as they complete one or more flights, at least one hosted aircraft condition monitoring user interface platform for hosting an aircraft condition monitoring system, the aircraft condition monitoring system for processing the staged ARS data to produce aircraft predictive maintenance determinations based on user-provided logic query conditions indicative of events that are relevant to the aircraft predictive maintenance determinations, at least one cloud tenant (e.g., serverless or dedicated) for receiving batch processing queries based on the user-provided logic query conditions to pre-filter the staged ARS data to produce relevant subsets of the staged ARS data, and one or more data warehouse platforms for receiving the relevant subset of the staged ARS data and producing condition monitoring outputs based on the user-provided logic query conditions and the relevant subsets of the staged ARS data.

Another embodiment includes a method for processing predictive aircraft sensor parameters in the context of predictive conditions, the predictive aircraft sensor parameters being associated with aircraft sensor data from at least one aircraft recording system (ARS), the ARS being associated with one or more monitored aircraft, the method comprising: capturing a plurality of newly received aircraft sensor values over the course of a plurality of aircraft flights taken by the one or more monitored aircraft, wherein the at least one ARS captures the newly received aircraft sensor values associated with a plurality of aircraft sensors in the one or more monitored aircraft, receiving user-provided logic query conditions indicative of events that are relevant to the aircraft predictive maintenance determinations, staging a relevant subset of the newly received aircraft sensor values into a cloud storage repository associated with a serverless cloud tenant for performing batch processing on the relevant subset of the newly received aircraft sensor values in connection with one or more data warehouses, and generating condition monitoring outputs based on the user-provided logic query conditions and the relevant subsets of the staged ARS data.

Yet another embodiment includes one or more non-transitory computer-readable media storing computer-executable instructions that, when executed by a processor, perform a method for processing predictive aircraft sensor parameters in the context of predictive conditions, the predictive aircraft sensor parameters being associated with aircraft sensor data from at least one aircraft recording system (ARS), the ARS being associated with one or more monitored aircraft, the method comprising: capturing a plurality of newly received aircraft sensor values over the course of a plurality of aircraft flights taken by the one or more monitored aircraft, wherein the at least one ARS captures the newly received aircraft sensor values associated with a plurality of aircraft sensors in the one or more monitored aircraft, receiving user-provided logic query conditions indicative of events that are relevant to the aircraft predictive maintenance determinations, staging a relevant subset of the newly received aircraft sensor values into a cloud storage repository associated with a serverless cloud tenant for performing batch processing on the relevant subset of the newly received aircraft sensor values in connection with one or more data warehouses, and generating condition monitoring outputs based on the user-provided logic query conditions and the relevant subsets of the staged ARS data.

### BRIEF DESCRIPTION OF THE DRAWING FIGURES

Embodiments of the invention are described in detail below with reference to the attached drawing figures, wherein:

FIG. 1 depicts a block diagram illustrating an example aircraft condition monitoring system for monitoring, filtering, and persisting aircraft data in connection with a highly performant data warehouse;

FIG. 2 depicts an example user interface diagram illustrating a user interface component for accessing processed condition monitoring logs in an aircraft condition monitoring system consistent with the present teachings;

FIG. 3 depicts another example user interface diagram illustrating a user interface component for accessing an Application Performance Monitoring (APM) solution regarding processed condition monitoring logs in an aircraft condition monitoring system consistent with the present teachings; and

FIG. 4 depicts a flow diagram illustrating an example method for providing aircraft condition monitoring system for monitoring, filtering, and persisting aircraft data in connection with a highly performant data warehouse.

The drawing figures do not limit the invention to the specific embodiments disclosed and described herein. The drawings are not necessarily to scale, emphasis instead being placed upon clearly illustrating the principles of the invention.

### DETAILED DESCRIPTION

The present teachings enable an in-depth, automation-focused, and customizable analytics tool to aircraft fleet operators and aircraft operators generally by providing a streamlined and highly performant process of discovery for data-centric queries associated with data available from aircraft recorder system (“ARS”) data. In some use cases, users of systems consistent with the present teachings may wish to query an aircraft condition monitoring data warehouse based on independently observed anomalous trends within certain aircraft sensor data occurring with their aircraft that the user would like to explore. In other use cases, a user may employ profiles including aircraft sensor values and/or sensor value trends that are known to be potentially relevant to aircraft predictive maintenance.

With aircraft condition monitoring data query strategies in hand, users of systems consistent with the present teachings can open an application, navigate to a “condition monitoring” tab, and build a custom query in connection with a user interface that monitors ARS flight data in substantially real time as such data are uploaded from ARS systems into data pipelines associated with condition monitoring one or more data warehouses consistent with the present teachings. Processes consistent with the present teachings may be initiated in connection with a custom query building user interface. In connection with such a user interface, users are provided with an opportunity to select one or more parameter names associated with data fields recorded in connection with one or more ARS. In some embodiments, users can construct such queries in connection with no-code Boolean logic statements such that selected parameters capture desired behavior of interest to the users. In some such embodiments, users can test the custom logic against a static file to ensure successful execution in the back end and submit the custom query to a database for batch processing and reporting on future flight files. As such systems consistent with the present teachings provide users with no-code interfaces to interact with data from ARS in a user-friendly and company-guided way allowing providers of systems consistent with the present teachings to enable granular access to ARS data of interest without a need to process or release massive ARS datasets to users. In embodiments, all parameters recorded by the ARS are selectable by the user.

In some embodiments, such query provision in connection with a data warehouse has the benefit of replacing functionality associated with conventional ARS diagnostic software, which can be computation-and data-heavy and cumbersome to maintain. Some conventional offerings are based on desktop applications that are required to process vast amounts of ARS data, and which typically lack in performance and useability. Users of such conventional systems can typically only look at one smaller subset of ARS flight data, such as an ARS flight file associated with a discrete set of flights, typically a single flight. By contrast, systems consistent with the present teachings provide insights into larger data sets, in aggregate, in some cases up to a point at which a condition query was created within a system consistent with the present teachings. In some embodiments, processing ARS data as set forth below provides highly performant reference to only the subset of ARS data of interest to users saving time, storage, and computational resources that would otherwise be required to identify flights (and associated ARS data) manually. In embodiments, the ARS data comprises continuous time-series data processed at a 1-Hz sample rate.

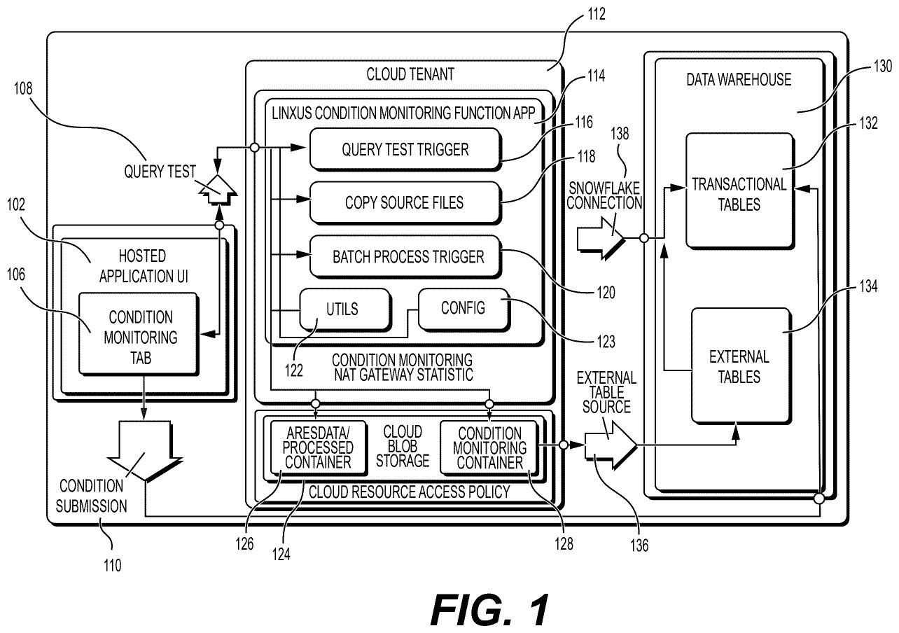

FIG. 1 depicts a block diagram illustrating an example aircraft condition monitoring system 100 for monitoring, filtering, and persisting aircraft data in connection with a highly performant data warehouse. In an embodiment such as depicted in connection with FIG. 1, an aircraft condition monitoring system comprises three principal components, hosted application user interface 102, cloud tenant 112, and data warehouse 130. A first component (user interface 102) provides user interface functionality. Such user interface functionality may be provided in connection with a hosted network application that provides access to the aircraft condition monitoring system by way of a conventional web browser. It is understood that such a hosted application may provide access to user interface functionality directly by rendering a user interface according to a markup language such as Hypertext Markup Language (“HTML”) sent and received over an application-layer protocol such as the Hypertext Transfer Protocol (“HTTP”) or a Secure Hypertext Transfer Protocol (“HTTPS”) however the present teachings are not limited to these standards and rather may provide a user interface using any similar or related functionality. Hosted user interface 102 need not be rendered in connection with a standard web browser but instead may be rendered in connection with any kind of front-end application user interface rendering functionality.

A second component (cloud tenant 112) provides back-end batch processing functionality. In connection with a primary user interface component (such as user interface 102), users can navigate to a “condition monitoring” tab 106 from which the users are able to build a customized condition in a no-code query builder environment. Some fields available to customize may include condition name, aircraft model, aircraft serial (single, range, or entire customer specific fleet), condition expiry date, and one or more logic statements based on ARS parameters that users can select from a searchable dropdown user interface component, for example.

To construct logic statements to be processed in connection with cloud tenant 112, certain ones of selected ARS parameters may be arranged with a set of comparison operators (such as, for example: <, >, <=, >=, !=) and the ARS parameters can then be grouped in sub statements with ‘AND’/‘OR’ grouping operators. For example, in connection with user interface 102, a logic statement could capture relationships like “(parameter 1>500 OR parameter 2<70) AND parameter 3!=42”. After the parameters are chosen and corresponding logic built, queries can be tested (in connection with query test 108) to ensure successful (and performant) execution in connection with back-end batch processes associated with one or more data warehouses such as data warehouse 130. In some embodiments, only successfully tested logic is permitted to be executed as a query, such as when query test 108 is successful. In some embodiments, a query test 108 initiates invocation of a query test trigger in connection with cloud tenant 112. This may involve invocation of a HTTPS triggered function that is passed a user defined logic query from the “condition monitoring” tab 106 to run a test query verifying that a particular logic query will not cause an error in connection with batch processing as implemented in connection with serverless cloud platform 112.

Next, reporting method selections are provided in connection with user interface 102 to enable users to decide how ARS parameter values and associated events may be filtered and tracked for reporting in connection with cloud tenant 112 and data warehouse 130. In some embodiments a plurality of check boxes may be provided. In some such embodiments, three check boxes may be provided. In these embodiments, one box allows users to set a duration for an ARS parameter condition to be true before an associated event is counted. In this case, for example, an event is counted only if a specified ARS parameter condition is present for more than a specified number of seconds, such as longer than seven seconds or less than 35 seconds. Such functionality may be employed to filter on duration values between zero elapsed time and effectively infinite elapsed time (or the duration of a flight, for example). A subsequent check box may be employed to permit users to only a single event per flight, even if there are multiple instances of the event in a single flight. For example, an event is recorded if a particular condition was valid at multiple separate times (e.g., three times) during the same flight, but would be recorded as a single event. A further check-box option may be provided to augment a previous check box to record an occurrence of an event only when such an event occurred for a user-defined number of flights. For example, such a condition would be true if a particular event occurred three times on at least four flights, in which case the 12 occurrences would be counted as one with this user-specified check box. Conversely, if such an event occurred three times on only three fights, such an event sequence would not be counted as a relevant event for the purpose of event filtering and reporting.

After successful submission of a condition (by condition submission process 110), such a condition may be managed in connection with options for management in an “all conditions” tab (not shown in FIG. 1) provided in connection with a condition management application consistent with the present teachings. In connection with such an application, a user's submitted conditions may be listed for interaction with and/or heartbeat metrics shown. Heartbeat metrics correspond to a chronological occurrence of one or more specified conditions as described above. The management options available to the user are the ability to edit a condition's fields and to activate or delete one or more conditions and to view and/or export data reports in various file formats, such as an .xlsx file format which is typically associated with a spreadsheet file format. Moreover, users may then download, and view reporting information associated with various associated serial numbers of specific aircraft. Once a condition is successfully submitted (in connection with condition submission process 110) to a query persistence store, one or more back-end batch processes may be configured to include such a stored query or condition to be included in connection with a subsequent batch run. Such active conditions may be deployed to identify occurrences of such conditions in subsequently acquired ARS data, such as in subsequently downloaded flight files for which the user defined query logic and/or conditions are satisfied. Metrics associated with the condition may then be recorded including a specified amount of data surrounding such a satisfied condition. Example metrics may include aggregate counts of events, or event identifying data for ad hoc analysis, in instances where an event is a distinct occurrence of the condition being true. For example, specified sensor parameters may be recorded and transmitted to a data warehouse before and after a satisfied query logic event or condition, as explained above.

As depicted in example, aircraft condition monitoring system 100 further batch-processing processes may be carried out in connection with cloud tenant 112. In connection with process block 118 source files containing ARS data may be copied. In some embodiments, process block 118 involves monitoring contents of one or more containers within cloud binary large object (BLOB) storage 124 such that creation of column-orientated data storage files relevant to active conditions may be identified. In some such embodiments, the column-orientated data storage files may be in the Apache Parquet file format. In these embodiments, files determined to be relevant may be subsequently copied to one or more condition monitoring staging locations. Next, at process block 120, a batch process trigger may be executed in connection with a timer that triggers one or more batch processes that executes one or more user defined queries, collecting and aggregating associated results. In some cases, results of the user defined queries may cause updates and insertions to transactional tables 133 associated with data warehouse 130. Utilities 122 and configuration parameters 123 may provide helper functions and configuration parameters, respectively, for cloud tenant 112.

In some embodiments, a further component (data warehouse 130) provides data warehousing functionality, such as that provided by Snowflake® Database “DataCloud” technology, from Snowflake, Inc. In these embodiments, serverless cloud tenant is connected to data warehouse 130 by way of Snowflake connection 138. In some such embodiments, one or more batch runs each involve four steps, which may be executed for each aircraft under condition monitoring. First, a set of associated database tables containing metadata about the user defined conditions and results from previous batch runs are checked for any active conditions. If there are active conditions, the process then cross references the flight files for the current batch (and current execution's model) with the condition metadata to determine whether there are any relevant new ARS data sources to process. Such ARS data sources may include, for example, flight files. Next, logic statements for specified and active conditions may be transformed into a template query. In some embodiments, such a template query, which may include custom developed query terms that may either be specified by a vendor of a particular condition monitoring system consistent with the present teachings and/or designed an optimized in connection with machine learning models that are used to improve template queries to minimize use of computational and storage resources. In some embodiments, such template queries may return results containing names of relevant flight files, timestamps of event occurrences, duration of events, and one or more unique identifiers tying query results to corresponding conditions and aircraft serial numbers. Next, results obtained in previous steps may be aggregated to counts of events that are deemed to have occurred in each flight file for a given condition and written to the appropriate fields of associated data warehouse tables. In some embodiments, to reduce storage and computation resource consumption, resources associated with a batch process may be released and thereby freed up. In some embodiments, execution of batch processes consistent with the present teachings may be implemented in connection with Python scripts and hosted via a serverless cloud computing environment (cloud tenant 112), such as an Azure Function App. In some embodiments, additional processes may be provided outside of the batch processes described in connection with cloud tenant 112, which monitor received flight files to identify flights that are relevant to currently active condition monitoring system conditions. Such additional process may further copy relevant files to one or more staging locations (not shown).

Condition monitoring application user interface 102 enables users to create custom queries that are executed over ARS data from specified aircraft having certain serial numbers as associated ARS data is uploaded to example aircraft condition monitoring system 100. Once a set of logic queries and/or aircraft parameter conditions have been submitted and ARS data associated with flights for this condition have begun to be uploaded to a storage location associated with cloud BLOB storage cloud tenant 112 may send out a message that an ARS flight data file has been created. Processes consistent with the present teachings listen for such messages and on receiving one or more such message may query the transactional tables 132 for enrolled models and/or aircraft serials numbers and cross-reference the newly received flight data file to determine whether the newly received flight data file is relevant. If so, the file is copied to a staging location and if not, it is logged and skipped. In some embodiments, such data staging processes occur outside batch processing functionality provided by cloud tenant 112.

In some embodiments, batch processing functionality provided in connection with cloud tenant 112 begins execution by accessing relevant conditions and aircraft metadata from transactional tables 132 and cross-references the files in staging locations with condition metadata to compute relevant file counts, determine if relevant files exist for a given condition, and curate this condition metadata for use later in batch processing. External tables 134 may provide a data repository from cloud BLOB storage 124. ARS processed container 126 and condition monitoring container 128 may provide data to process blocks contained within cloud tenant 112. Any results returned from the user defined condition logic is aggregated and written to the transactional tables 132.

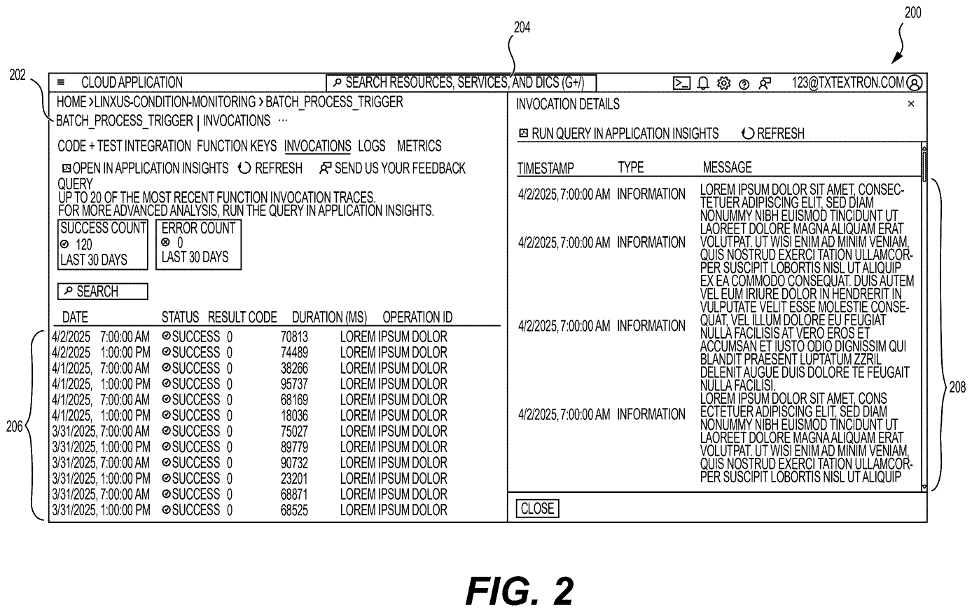

FIG. 2 depicts an example user interface diagram 200 illustrating a user interface component for accessing processed condition monitoring logs in an aircraft condition monitoring system consistent with the present teachings. User interface component 202 depicts a user interface component for interacting with batch process trigger interactions, enabling users of example aircraft condition monitoring system 100 (as depicted in connection with FIG. 1) to gain insights into aircraft condition monitoring query results. User interface component 204 provides free-form search functionality into aircraft condition monitoring reporting results such as those depicted in connection with into aircraft condition monitoring reporting log table 206, including dates, statuses, result codes, durations, and operation identifiers. Similarly, invocation details table 208 provides details regarding condition monitoring application insight condition reporting invocations including time stamps, types and associated messages.

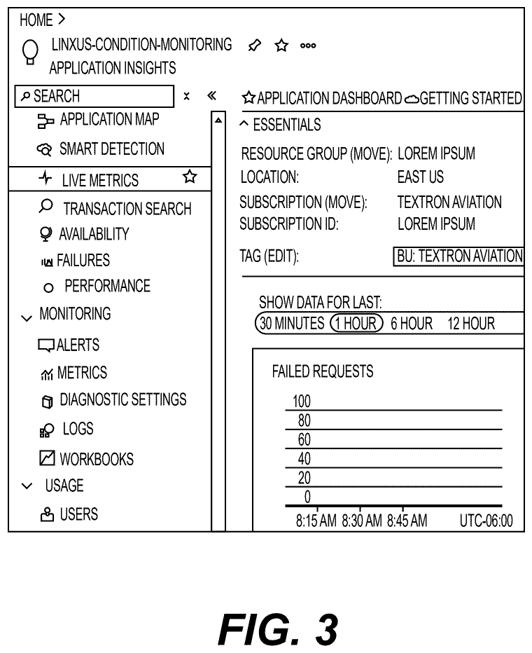

FIG. 3 depicts another example user interface diagram illustrating a user interface component for accessing an Application Performance Monitoring (APM) solution regarding processed condition monitoring logs in an aircraft condition monitoring system consistent with the present teachings. One example of an APM solution is Application Insights from the Microsoft Azure service, but other APM solutions may be employed without departing from the scope hereof. In some embodiments, users may view logs from an APM user interface component associated with condition monitoring user interface 102 (of FIG. 1). Users may accomplish this by navigating to an APM page by locating a link in a monitoring section of the condition monitoring user interface 102 and clicking a link to view APM data. From this location, users may run one or more template queries, one or more preset queries or exit the prompt and run a previous query.

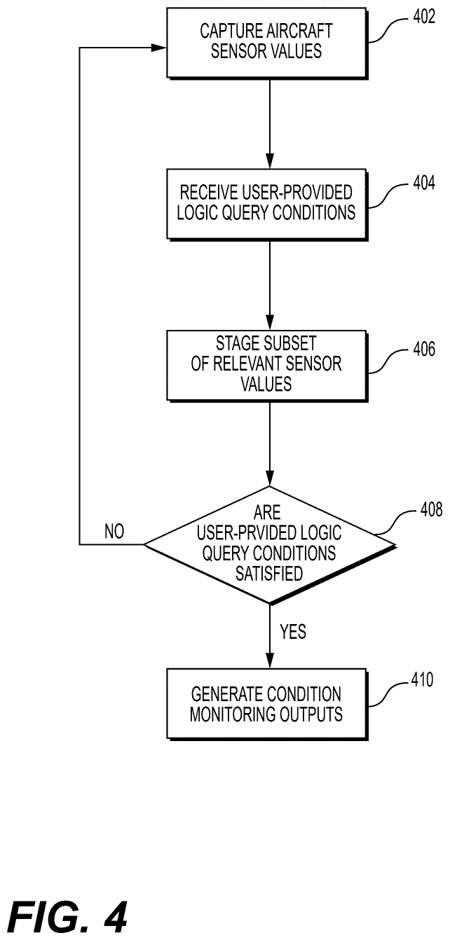

FIG. 4 depicts a flow diagram illustrating an example method 400 for providing aircraft condition monitoring system for monitoring, filtering, and persisting aircraft data in connection with a highly performant data warehouse. At step 402, a plurality of newly received aircraft sensor values is captured over the course of a plurality of aircraft flights taken by a monitored aircraft, wherein the ARS captures the newly received aircraft sensor values associated with a plurality of aircraft sensors in the monitored aircraft. Each aircraft is installed with an ARS that records data from that respective aircraft. At step 404, user-provided logic query conditions indicative of events that are relevant to the aircraft predictive maintenance determinations are received. At step 406, a relevant subset of the newly received aircraft sensor values is staged into a cloud storage repository associated with a serverless cloud tenant for performing batch processing on the relevant subset of the newly received aircraft sensor values in connection with one or more data warehouses. In some embodiments, the newly acquired ARS data may be staged in the form of one or more column-orientated data storage files, such as for example files that stored in the Apache Parquet format. In some other embodiments, the newly acquired ARS data is staged in the form of one or more cloud storage binary large objects. At test 408, it is determined whether user-provided logic query conditions are satisfied by the relevant subsets of the staged ARS data. In some embodiments, the user-provided logic query conditions are satisfied in a case under which a single event occurs in any number of flights. In some embodiments, the user-provided logic query conditions are satisfied in a case of which a user-specified number of events occurs within a user-specified specified number of flights. In some other embodiments, the user-provided logic query conditions are satisfied based upon chronological occurrence of one or more specified conditions. Moreover, if the user-provided logic query conditions are present for more than a user-specified number of seconds. If at test 408, the user-provided logic query conditions are satisfied, at step 410, condition monitoring outputs are generated indicating potentially maintenance predictive actions that should be taken in connection with one or more monitored aircraft. Otherwise, execution continues to step 402 in which additional aircraft sensor values are collected.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An aircraft condition monitoring system for analyzing aircraft data associated with one or more monitored aircraft, the aircraft condition monitoring system comprising:
at least one aircraft recording system (ARS) for capturing a plurality of aircraft sensor values over the course of a plurality of flights of the one or more monitored aircraft, wherein the at least one ARS captures aircraft sensor values associated with a plurality of aircraft sensors;
one or more data acquisition endpoints associated with the aircraft recording system, for staging newly acquired ARS data as staged ARS data is received from aircraft as they complete one or more flights;
at least one hosted aircraft condition monitoring user interface platform for hosting an aircraft condition monitoring system, the aircraft condition monitoring system for processing the staged ARS data to produce aircraft predictive maintenance determinations based on user-provided logic query conditions indicative of events that are relevant to the aircraft predictive maintenance determinations;
at least one serverless cloud tenant for receiving batch processing queries based on the user-provided logic query conditions to pre-filter the staged ARS data to produce relevant subsets of the staged ARS data; and
one or more data warehouse platforms for receiving the relevant subset of the staged ARS data and producing condition monitoring outputs based on the user-provided logic query conditions and the relevant subsets of the staged ARS data.

2. The aircraft condition monitoring system of claim 1, wherein the newly acquired ARS data is staged in the form of one or more column-orientated data storage files.

3. The aircraft condition monitoring system of claim 1, wherein the newly acquired ARS data is staged in the form of one or more cloud storage binary large objects.

4. The aircraft condition monitoring system of claim 1, wherein the user-provided logic query conditions are satisfied in a case of which a single event occurs in any number of flights.

5. The aircraft condition monitoring system of claim 1, wherein the user-provided logic query conditions are satisfied in a case of which a user-specified number of events occurs within a user-specified specified number of flights.

6. The aircraft condition monitoring system of claim 5, wherein the user-provided logic query conditions are satisfied based upon chronological occurrence of one or more specified conditions.

7. The aircraft condition monitoring system of claim 1, wherein the user-provided logic query conditions are present for more than a user-specified number of seconds.

8. A method for processing predictive aircraft sensor parameters in the context of predictive conditions, the predictive aircraft sensor parameters being associated with aircraft sensor data from at least one aircraft recording system (ARS), the ARS being associated with one or more monitored aircraft, the method comprising:
capturing a plurality of newly received aircraft sensor values over the course of a plurality of aircraft flights taken by the one or more monitored aircraft, wherein the at least one ARS captures the newly received aircraft sensor values associated with a plurality of aircraft sensors in the one or more monitored aircraft;
receiving user-provided logic query conditions indicative of events that are relevant to the aircraft predictive maintenance determinations;
staging a relevant subset of the newly received aircraft sensor values into a cloud storage repository associated with a serverless cloud tenant for performing batch processing on the relevant subset of the newly received aircraft sensor values in connection with one or more data warehouses; and
generating condition monitoring outputs based on the user-provided logic query conditions and the relevant subsets of the staged ARS data.

9. The method of claim 8, wherein the newly acquired ARS data is staged in the form of one or more column-orientated data storage files.

10. The method of claim 9, wherein the newly acquired ARS data is staged in the form of one or more cloud storage binary large objects.

11. The method of claim 8, wherein the user-provided logic query conditions are satisfied in a case of which a single event occurs in any number of flights.

12. The method of claim 11, wherein the user-provided logic query conditions are satisfied in a case of which a user-specified number of events occurs within a user-specified specified number of flights.

13. The method of claim 11, wherein the user-provided logic query conditions are satisfied based upon chronological occurrence of one or more specified conditions.

14. The method of claim 11, wherein the data staging processes occur outside batch processing functionality provided by the serverless cloud tenant.

15. One or more non-transitory computer-readable media storing computer-executable instructions that, when executed by a processor, perform a method for processing predictive aircraft sensor parameters in the context of predictive conditions, the predictive aircraft sensor parameters being associated with aircraft sensor data from at least one aircraft recording system (ARS), the ARS being associated with one or more monitored aircraft, the method comprising:
capturing a plurality of newly received aircraft sensor values over the course of a plurality of aircraft flights taken by the one or more monitored aircraft, wherein the at least one ARS captures the newly received aircraft sensor values associated with a plurality of aircraft sensors in the one or more monitored aircraft;
receiving user-provided logic query conditions indicative of events that are relevant to the aircraft predictive maintenance determinations;
staging a relevant subset of the newly received aircraft sensor values into a cloud storage repository associated with a serverless cloud tenant for performing batch processing on the relevant subset of the newly received aircraft sensor values in connection with one or more data warehouses; and
generating condition monitoring outputs based on the user-provided logic query conditions and the relevant subsets of the staged ARS data.

16. The non-transitory computer-readable media of claim 15, wherein the newly acquired ARS data is staged in the form of one or more column-orientated data storage files.

17. The non-transitory computer-readable media of claim 15, wherein the newly acquired ARS data is staged in the form of one or more cloud storage binary large objects.

18. The non-transitory computer-readable media of claim 15, wherein the user-provided logic query conditions are satisfied in a case of which a user-specified number of events occurs within a user-specified specified number of flights.

19. The non-transitory computer-readable media of claim 15, wherein the user-provided logic query conditions are satisfied based upon chronological occurrence of one or more specified conditions.

20. The non-transitory computer-readable media of claim 19, wherein user-provided logic query conditions are present for more than a user-specified number of seconds.
